(19) United States
(12) Patent Application Publication
(10) Pub. No.: US 2017/0220974 A1
(43) Pub. Date: Aug. 3, 2017

(54) RESOURCE OPTIMIZATION FOR PRODUCTION EFFICIENCY

(71) Applicant: SAP SE, Walldorf (DE)

(72) Inventors: Mengjiao WANG, Shanghai (CN); Wen-Syan LI, Shanghai (CN)

(21) Appl. No.: 15/010,943

(22) Filed: Jan. 29, 2016

(51) Int. Cl. G06Q 10/06

(52) U.S. Cl. CPC G06Q 10/063116

(57) ABSTRACT

Software techniques are described for making predictions and associated decisions regarding resource optimization for production efficiency, and scheduling associated actions accordingly. For example, with respect to a large workforce of employees eligible for available or potential training programs, techniques are described for making eligibility decisions regarding the training programs based at least in part on predicting whether and when an employee or subset of employees will depart a company, as well as on predicting a future business demand for the skills conferred by the training program(s). Similarly, with respect to machine resources, techniques are described for predicting whether and when a machine will malfunction, as well as for predicting a future demand for the functions provided by the new or upgraded machine functionality. In this way, businesses may make intelligent decisions regarding whether, when, and how to invest in available resources, in order to increase efficiency, productivity, and profitability.

### TECHNICAL FIELD

This description relates to data analysis for predictive scheduling.

### BACKGROUND

High volumes of data are captured, stored, and available for use in various types of decision-making. However, it is often difficult or impossible for human users of such data to interpret and apply the data, and to engineer computers to operate based on the data and in a manner that optimizes use of the available data.

Computers are often used in various types of scheduling operations, and many such scheduling operations are straightforward. In some contexts, however, it is still difficult or impossible to make large-scale, accurate, and/or timely scheduling decisions, particularly when certain scheduling constraints exist, and/or when a large number of scheduling variables are present.

For example, it is difficult to upgrade, maintain, or otherwise optimize available resources, such as machine resources, or human resources. With respect to human resources, employees may benefit from receiving new training, so as to learn new skills that will make the employees more versatile, more efficient, and more productive. However, such potential benefits may be outweighed by the costs of the training programs, e.g., in situations in which the employees depart the company before the training costs are recovered, and/or in situations in which a demand for the new skillset is not sufficiently high. Somewhat similarly, with respect to machine resources, equipment may benefit from being upgraded, replaced, or serviced. However, again, the associated benefits may not be realized or optimized if the associated costs are too high, the machine resource reaches an end of its functional life, and/or if the demand for the machine function is not high enough. In short, it is difficult to predict when to invest in improving available resources, relative to utilizing available resources at their current level of capacity or ability.

### SUMMARY

In the present description, software techniques are described for making predictions and associated decisions regarding resource optimization for production efficiency, and scheduling associated actions accordingly. For example, with respect to a large workforce of employees eligible for available or potential training programs, techniques are described for making eligibility decisions regarding the training programs based at least in part on predicting whether and when an employee or subset of employees will depart a company, as well as on predicting a future business demand for the skills conferred by the training program(s). Similarly, with respect to machine resources, techniques are described for predicting whether and when a machine will malfunction, as well as for predicting a future demand for the functions provided by the new or upgraded machine functionality. In this way, businesses may make intelligent decisions regarding whether, when, and how to invest in available resources, in order to increase efficiency, productivity, and profitability.

According to one general aspect, a computer program product is tangibly embodied on a non-transitory computer-readable storage medium and includes instructions. The instructions, when executed, are configured to cause at least one computing device to receive an optimization request for generating a resource improvement schedule in which a plurality of resources are scheduled for a plurality of improvement activities, the resource improvement schedule associated with a budget constraint, access a resource database to retrieve the plurality of resources from a plurality of stored resources, and access an improvement database to retrieve the plurality of improvement activities from a plurality of stored improvement activities. The instructions, when executed, are further configured to cause the at least one computing device to generate an initial resource improvement schedule that includes a plurality of relationships, each relationship defined between individual resources and individual improvement activities, and execute iterations to improve the initial optimization schedule. Each current iteration includes calculating an optimization variable for each relationship, sampling a preceding resource improvement schedule from a preceding iteration, based on values of optimization variables in the preceding resource improvement schedule, to thereby retain a subset of the relationships of the preceding resource improvement schedule, and determining whether the retained subset has costs greater than the budget constraint, and re-executing the sampling if so, or, if not, generating additional relationships for inclusion in a subsequent iteration. The instructions, when executed, are further configured to cause the at least one computing device to stop the iterations at a final iteration associated with an iteration stop condition, to thereby obtain the resource improvement schedule.

According to another general aspect, a method of executing instructions stored on a non-transitory computer-readable storage medium using at least one processor includes receiving an optimization request for generating a resource improvement schedule in which a plurality of resources are scheduled for a plurality of improvement activities, the resource improvement schedule associated with a budget constraint, accessing a resource database to retrieve the plurality of resources from a plurality of stored resources, and accessing an improvement database to retrieve the plurality of improvement activities from a plurality of stored improvement activities. The method further includes generating an initial resource improvement schedule that includes a plurality of relationships, each relationship defined between individual resources and individual improvement activities, and executing iterations to improve the initial optimization schedule. Each current iteration includes calculating an optimization variable for each relationship, sampling a preceding resource improvement schedule from a preceding iteration, based on values of optimization variables in the preceding resource improvement schedule, to thereby retain a subset of the relationships of the preceding resource improvement schedule, and determining whether the retained subset has costs greater than the budget constraint, and re-executing the sampling if so, or, if not, generating additional relationships for inclusion in a subsequent iteration. The method further includes stopping the iterations at a final iteration associated with an iteration stop condition, to thereby obtain the resource improvement schedule.

According to another general aspect, a system includes at least one processor, and a non-transitory computer-readable storage medium storing instructions executable by the at least one processor. The system includes an optimization request handler configured to cause the at least one processor to receive an optimization request for generating a resource improvement schedule in which a plurality of resources are scheduled for a plurality of improvement activities, the resource improvement schedule associated with a budget constraint. The system includes a loss rate predictor configured to calculate a predicted future availability of a resource, as determined from historical analysis of availabilities of similar resources. The system includes an iteration calculator configured to cause the at least one processor to execute iterations to obtain the resource improvement schedule. Each current iteration includes calculating an optimization variable for each relationship, based on the predicted future availability of the resource of the corresponding relationship, sampling a preceding resource improvement schedule from a preceding iteration, based on values of optimization variables in the preceding resource improvement schedule, to thereby retain a subset of the relationships of the preceding resource improvement schedule, and determining whether the retained subset has costs greater than the budget constraint, and re-executing the sampling if so, or, if not, generating additional relationships for inclusion in a subsequent iteration.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for resource optimization for production efficiency.

FIG. 2 is a flowchart illustrating example implementations of the system of FIG. 1.

FIG. 3 is a flowchart illustrating initialization techniques to initiate iterative processing by the system of FIG. 1.

FIG. 4 is a flowchart illustrating iterative techniques for operating the system of FIG. 1, using the initialization results of FIG. 3.

### DETAILED DESCRIPTION

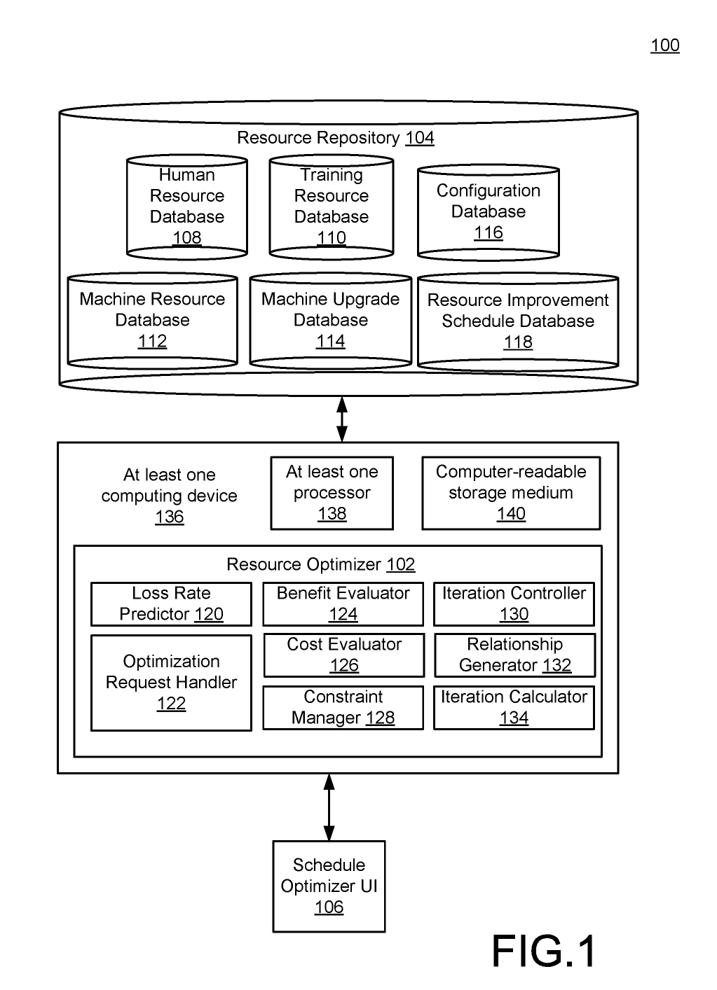

FIG. 1 is a block diagram of a system 100 for resource optimization in production environments. In the example of FIG. 1, a resource optimizer 102 is configured to process data stored within a resource repository 104, in order to provide an optimization schedule in which a plurality of resources are scheduled for a plurality of improvement activities, subject to one or more constraints, such as budget constraints. A resulting optimization schedule may be provided, e.g., using a resource optimization user interface (UI) 106. In this way, for example, various improvement activities may be scheduled for available resources, including human resources as well as machine resources, even while taking into account various constraints and other factors.

In the example of FIG. 1, as referenced above, it is assumed that the system 100 is implemented in, or in conjunction with some type of production environment, and/or other related context. For example, in many of the example scenarios provided below, the system 100 may be implemented in conjunction with a manufacturing facility, in which one or more types of physical goods are constructed, assembled, manufactured, or otherwise provided or produced. Additionally, or alternatively, production environments may refer to productions of services, as well as tangible goods. Accordingly, production contexts should be understood to represent or include, e.g., factory, warehouse, or retail contexts, to provide a few, non-limiting examples.

As also referenced above, it is assumed that various quantities and types of resources are available and utilized in the corresponding type of production environment, and that one or more options are available for improving an efficiency, functionality, or other aspect of the various resources. For example, human resources, e.g., employees or contractors, represent one type of resource, where human resources are understood to engage in improvement activities including, e.g., training, education, or other types of instruction/learning. Accordingly, the resource repository 104 illustrates a human resource database 108 that may be configured to store data enumerating and characterizing individual human resources. More detail regarding example implementations of the human resource database 108 is provided below, but, in general, it will be appreciated that the human resource database 108 may be configured to store individual employee data records, where each employee data record may characterize a job position or role, current length of employment, a current efficiency level or skill level, salary, availability, or other characteristic of the associated employee.

Meanwhile, a training resource database 110 may be configured to store all available training resources, including, e.g., training programs, classes, online learning, mentorships, or any other available program or activity that may be available to one or more of the human resources stored using the human resource database 108. For the sake of simplicity and conciseness, such training resources may be referred to uniformly as training programs in the following description.

Within the training resource database 110, such training programs may individually be characterized with respect to, e.g., a cost, duration, content, and impact on an efficiency/skill level of an employee who successfully completes the training program. With respect to cost, it will be appreciated that such cost may be measured directly or indirectly. For example, it may occur that an employee is paid a same or different salary or wage while taking a given training program. Additionally, or alternatively, individual training programs may be associated with specific fees and expenses.

Each training program is thus associated with an aggregate cost and aggregate benefit, so that a net benefit provided by various employees taking various training programs may vary widely. In practice, such net benefits may be dramatically affected by a duration of an employee's employment following completion of the training program. For example, if significant costs are incurred in conjunction with providing a specific employee with a specific training program, and then the employee resigns and departs, little or none of the benefits of the training program will be realized.

Similar comments apply to a machine resource database 112, which may be configured to store data records corresponding to individual machine resources that may be found in the types of production environments described herein. For example, as referenced above, such machines may include virtually any mechanical devices, including, for example, mechanical devices used to assemble, construct, paint, transport, or otherwise manipulate or utilize raw materials, components, or other production elements to provide finished products. As with the human resources, the various machines (or components thereof) may be listed and characterized within the machine resource database 112, such as with respect to functions performed, efficiencies provided, maintenance schedules, and other descriptive, relevant information, some of which is described below by way of further example.

A machine upgrade database 114 may be configured with all available machine upgrades for corresponding machines of the machine resource database 112. For example, such upgrades may include repair or maintenance programs, entire replacements of individual components or assemblies of one or more machines, or replacement options for upgrading a specific machine or type of machine to an entirely new model or type. As with the training resource database 110, the machine upgrade database 114 may be configured to store data characterizing the various available machine upgrades. For example, the machine upgrade database 114 may store information characterizing a downtime during which a given machine would be unavailable during upgrade activities. External costs associated with purchasing and installing the upgraded/replacement machine parts or machines also may be stored.

By way of analogy with the example of the human resource database 108 and the training resource database 110, a net benefit of performing a particular machine upgrade for a particular machine or type of machine may be affected significantly by an amount and extent to which the upgraded machine continues to function satisfactorily in a time following the upgrade. For example, if a machine is upgraded with a replacement component, but then experiences complete failure of other components assumed thereafter, such that the machine must be replaced in its entirety, there may be no net benefit, or may be a net cost, for the executed machine upgrade.

In theory, it would always be possible to upgrade or update machine resources with the latest available machine resources, or to always provide employees with available training programs. In practice, of course, the cost associated with these and other types of improvement activities force practical limitations to be considered. For example, a finite budget limits the number of machine resource components or replacements that can be purchased and installed at a given time, and, similarly, fees and expenses associated with training programs are also restrictive. Further, as referenced herein, opportunity costs associated with a downtime of a machine resource being repaired or replaced or upgraded should be considered, as should opportunity costs associated with employees being removed from active production to engage in training programs.

It is possible to assign human or machine resources for improvement activities using various metrics or techniques. For example, resources may be assigned for improvement activities on a first-come first-serve basis. For example, employees having seniority or requesting training programs relatively sooner than other employees could be assigned first. However, such simplified techniques do not consider associated costs and benefits. In particular, for a given number N of resources and a given number of M of improvement activities, a number of possible relationships between resources and improvement activities grows in a non-linear fashion. Consequently, finding an optimized number and type of such relationships becomes a non-polynomial (NP) hard problem that is beyond a human capability of solving in any practical manner or timeframe, or with any acceptable degree of reliability, particularly when one employee is eligible for multiple training programs (or one machine resource is eligible for multiple upgrades).

In contrast, the resource optimizer 102 may be configured to execute machine learning techniques for exploring a vast solution space of potential relationships between resources and improvement activities, while considering various constraints and characteristics associated therewith. In the example of FIG. 1, a configuration database 116 may be used to store various configuration parameters governing operations of the resource optimizer 102 during specific implementations thereof. Examples of such configuration parameters are provided in detail below, e.g., in conjunction with various individual components of the resource optimizer 102. As also described below, contents of the configuration database 116 may be input, modified, or updated using the resource optimization UI 106.

Thus, as just referenced, in operation, the resource optimizer 102 is configured to execute optimization activities in determining relationships between resources and improvement activities, while considering various associated constraints and other factors, so as to provide one or more resource optimization schedules to be stored within a resource improvement schedule database 118. Details regarding example implementations of the resource improvement schedule database 118, including example formats and structures for the data stored therein, are provided below.

In the present context, the term optimization (or optimized, or similar) should be understood to refer to a process by which potential relationships and associated schedules for available resources and potential improvement activities are iteratively calculated and evaluated by the resource optimizer 102, in which the iterative calculations (over a sufficient number of iterations) generally result in progressively improving results, where such improvements can be quantified, measured, and evaluated. Such optimization does not necessarily result in a single best solution, or guarantee that a single, current calculation is necessarily an improvement over a preceding calculation. Nonetheless, as described herein, operations of the resource optimizer 102 ultimately provide a resource optimization schedule or schedules that represent substantial and quantifiable improvements (e.g., as measured in terms of efficiency, productivity, reliability, or profit), as compared to existing techniques, including the types of trial and error techniques that might typically be employed. Moreover, such optimizations may be determined more quickly, more easily, and more reliably.

In operation, the resource optimizer 102 utilizes a loss rate predictor 120, which is configured to predict quantifiable rates of loss for individual resources, groups of resources, or types of resources. For example, with respect to machine resources, the loss rate predictor 120 may be configured to predict a quantity of time until a particular machine resource, or component thereof, experiences a specific type or extent of failure or malfunction. With respect to human resources, the loss rate predictor 120 may be configured to generate quantifiable predictions or estimations regarding whether and when a particular employee will depart, become promoted or reassigned, or otherwise become unavailable for future production activities or other related tasks.

In other words, as referenced above, and described in detail below, it is undesirable to incur costs associated with improvement activities (e.g., training programs, or machine upgrades), in scenarios in which the corresponding human or machine resources will become unavailable relatively soon after such costs are incurred. Consequently, the loss rate predictor 120 may be configured to access the human resource database 108, the machine resource database 112, and any other relevant sources of information, so as to periodically, continually, or on demand, calculate a current prediction (e.g., probability, or probability distribution) that a particular resource will become unavailable at a given point in time in the future.

For example, as described in detail below, the loss rate predictor 120 may make such predictions based on historical data regarding a duration of employment of employees, perhaps based on a manner and extent to which a given employee is similar to previous employees who became unavailable. More specifically, a conditional probability may be calculated that characterizes the chances that an employee who has been employed for a certain amount of time, in a certain role or position, having a certain educational background or skill set, or otherwise being associated with specific characteristics, will become unavailable within an identified timeframe. For example, the loss rate predictor 120 may determine that, historically, a certain number of percentage of employees having a certain education level and employed in a particular role for a particular number of years, did, in fact, depart or otherwise become unavailable (e.g., receive a promotion or reassignment). Then, the loss rate predictor 120 also may consider various associated timing considerations, such as an overall duration of each employee's employment, and/or a quantity of time measured from completion of a particular training program, promotion, or other milestone.

Similarly, the loss rate predictor 120 may access the machine resource database 112 to analyze historical data and trends regarding availability and functionality of individual machines, individual machine components, or categories of machines. For example, as just referenced with respect to human resources, the loss rate predictor 120 may determine a total number or percentage of machines that become unavailable after associated time durations, where the durations may be measured with respect to an overall period of operation, a quantity of time since a most recent maintenance, repair, or upgrade event, or other operational characteristics of the analyzed machines. For example, loss rate predictions may be made based on a number of operations or uses of the machine in question, rather than, or in addition to, a quantity of time during which the machine was deployed.

An optimization request handler 122 may be configured to receive specific optimization requests from an operator or other user of the system 100, e.g., by way of the resource optimization UI 106. For example, an operator may provide an optimization request specifying particular employees, either individually or by category, and perhaps in conjunction with specific training programs identified from within the training resource database 110.

For example, in some cases, individual employees may not be eligible for, or qualified to take, specific individual training programs of the training resource database 110. In some implementations, the optimization request handler 122 may filter the optimization request to determine such ineligibilities, and to remove specific employees and/or training programs, accordingly.

Of course, similar comments would apply to optimization requests received by the optimization request handler 122 and related to machine resources of the machine resource database 112, in conjunction with potential machine upgrades available with the machine upgrade database 114. Again, the optimization request handler 122 may deploy various types and extents of automated identification and selection of relevant or available machine resources and machine upgrades.

Once the optimization request has been received by the optimization request handler 122, a benefit evaluator 124 may be configured to process the optimization request and determine an associated benefit that would be projected to be obtained from providing one or more specific improvement activities to one or more corresponding resources. As described in detail below, the benefit evaluator 124 is configured to provide quantifiable, repeatable characterizations of the benefits to be obtained. For example, with respect to human resources potentially engaged in one or more associated training programs, the benefit evaluator 124 may calculate or project improved efficiencies or productivity of the individual employee. For example, such benefits may be calculated based on analysis of historical human resource data from the human resource database 108 in which similar or comparable employees were provided with the same or similar training programs, and preceding and subsequent production activities and associated efficiencies were measured and recorded.

Similarly, the benefit evaluator 124 may analyze historical machine resource data from the machine resource database 112, along with machine upgrade data from the machine upgrade database 114, in order to identify and analyze upgrade scenarios in which specific machines were upgraded. Again, if machine efficiencies or other operational performance metric are recorded for a particular machine in time periods that occur both before and after associated historical machine upgrades, then the benefit evaluator 124 may utilize such machine resource data to calculate relative performance metrics, and thereby determine and quantify improvements in associated efficiency or productivity metric for the machine in question.

Somewhat similarly, a cost evaluator 126 may be configured to analyze historical resource data and thereby quantify specific costs incurred for providing improvement activities to corresponding human or machine resources in the historical context. As already referenced, such costs may include the actual fees incurred for the improvement activities (e.g., tuition and supplies, or purchase prices for machine costs and associated installation labor costs). In addition to these types of explicit costs, implicit or otherwise related costs may be calculated and quantified. For example, costs may be associated with a downtime of an employee undergoing training programs, such as the salary of the employee that is still paid during the training program, any salary associated with a temporary or replacement employee assigned during a duration of the training program in question, and/or any loss of productivity (and associated decreases in sales) that may occur as a result of the employee being absent for the training program in question. Similarly with respect to machine resources, costs may include replacement costs for obtaining and utilizing a replacement machine, or an opportunity cost characterizing any reduction in sales or other metric that may be experienced during a time in which a corresponding upgrade is executed.

Further, a constraint manager 128 may be configured to receive, identify, or otherwise determine one or more constraints associated with optimization processes for the received optimization request. For example, as referenced above and described in more detail below, such constraints may include a quantified business demand for benefits provided by a providing of specific improvement activities. Additionally, or alternatively, constraints may include a total training budget available for incurring the cost associated with operations of the cost evaluator 126 as just described, including a requirement that the total training cost cannot exceed a specified training budget.

As referenced above, in some implementations, some of the calculations of the loss rate predictor 120, the benefit evaluator 124, the cost evaluator 126, and the constraint manager 128 may be executed on an as-needed or on-demand basis, e.g., in response to a specific optimization request received by the optimization request handler 122. For example, such calculations may be executed only with respect to subsets of the resource repository 104 considered to be relevant for corresponding aspects of the current optimization request. Additionally, or alternatively, some of these calculations may be executed periodically, so that associated calculation results will effectively be pre-calculated and therefore available upon receipt of a specific optimization request.

An iteration controller 130 may be configured to govern operations of a relationship generator 132 and an iteration calculator 134 in executing a number of iterations determined necessary to provide the desired optimized resource improvement schedule. For example, the iteration controller 130 may determine which optimization request received by the optimization request handler 122 will be processed, and may access the configuration database 116 to determine various associated parameters for the iterative processing. For example, as described in more detail below, the iteration controller 130 may determine one or more stop conditions associated with completing the iterative processing, including, e.g., a maximum number of iterations, a maximum amount of time spent iterating, a value of an optimization variable obtained during the iterative processing, and/or the specified relative levels of variations in the values of the optimization variable between iterations.

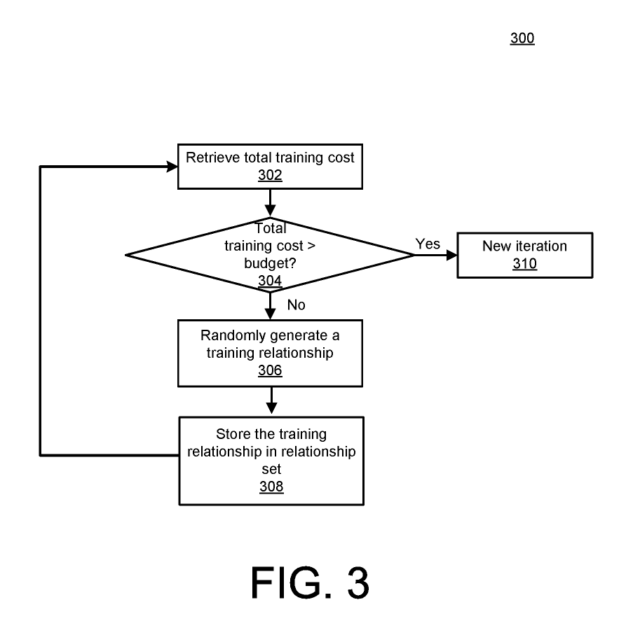

In operation, the relationship generator 132 is configured to generate a set of relationships that may exist between resources and improvement activities specified within the received optimization request and accessed from the resource repository 104. For example, for a subset of human resources who are eligible for participation in a subset of training programs, the relationship generator 132 may generate a number of potential training relationships and associated schedules. With respect to machine resources, the relationships may include upgrade relationships for upgrading components or other portions of the specified machine resources. As described below with respect to FIG. 3, the total (maximum) number of generated training relationships may be dictated by considering a total cost, as obtained from the cost evaluator 126, in conjunction with one or more budget constraints, as determined by the constraint manager 128.

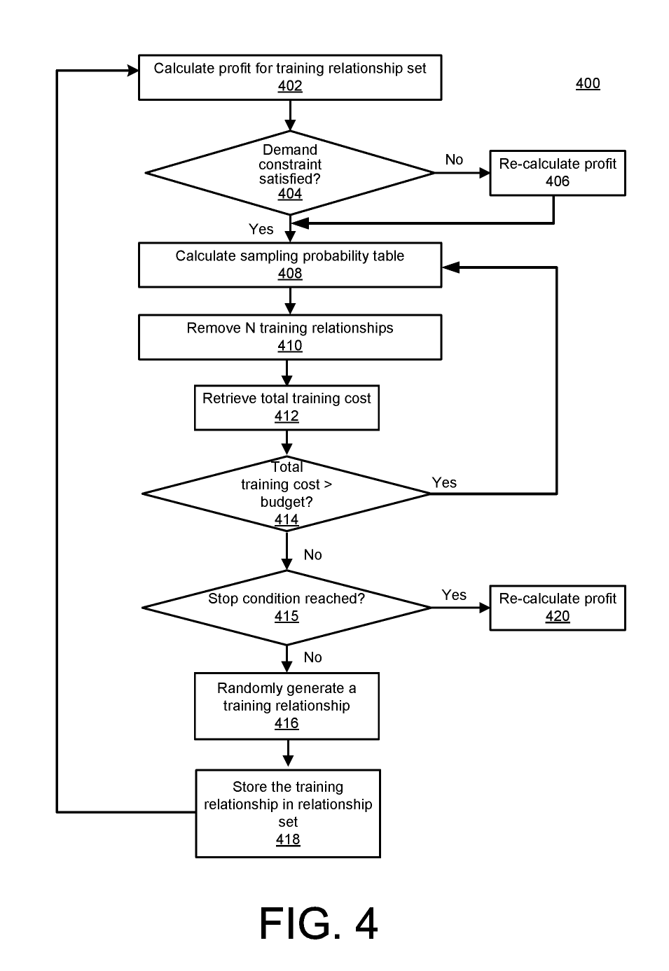

Then, the iteration calculator 134 may proceed to execute a current iteration, as described in more detail below with respect to FIG. 4. In general, the iteration calculator 134 is configured to calculate an optimization variable for the generated training relationships. In the examples that follow, the optimization variable may be considered to represent a profit that is projected to be obtained from the set of training relationships as a whole, as determined from the benefit evaluator 124, the cost evaluator 126, and the loss rate predictor 120.

The iteration calculator 134 may also be configured to sample or filter the generated relationships, until a total associated cost is less than the relevant budget constraint. Then, the relationship generator 132 may generate a new relationship(s), and the next iteration may proceed with a recalculation of a total value for the optimization variable (e.g., profit) projected to be obtained with the set of training relationships in the current iteration.

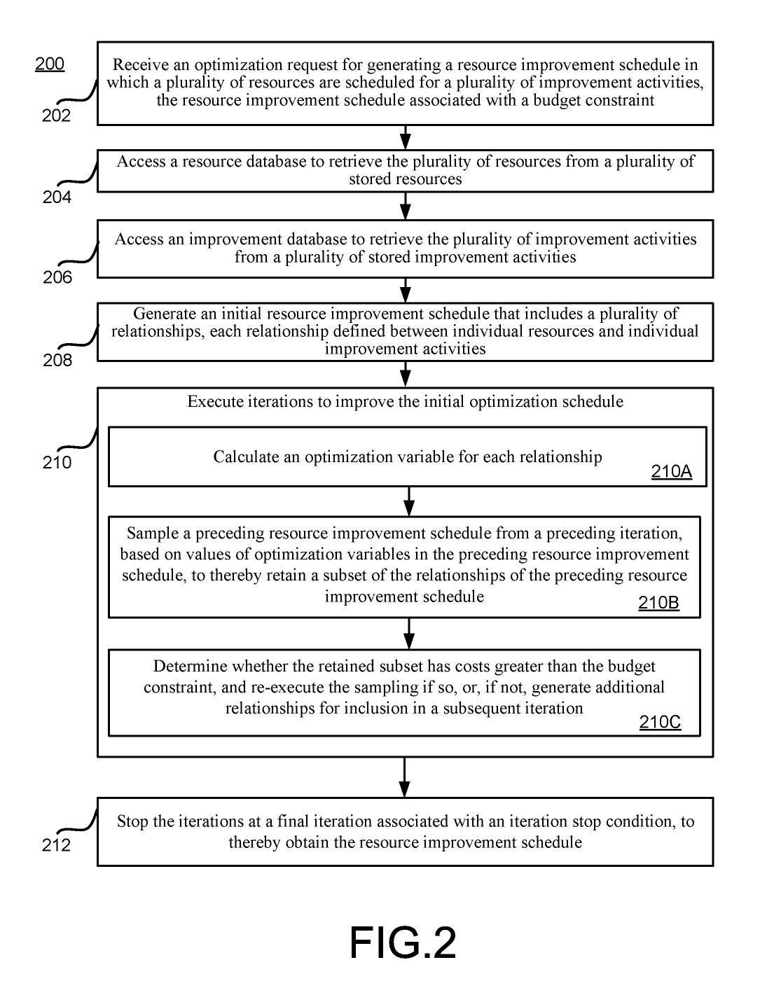

Further example details regarding operations of the iteration controller 130, the relationship generator 132, and the iteration calculator 134 are provided below with respect to FIGS. 2-4, including a manner in which additional constraints (e.g., demand-related constraints) are considered, as well as example techniques for sampling or filtering current sets of training relationships in each current iteration.

In general, however, it will be appreciated that the resource optimizer 102 is configured to populate the resource improvement schedule database 118 with an optimized resource improvement schedule for an associated, specified set of resources and improvement activities. In example implementations, the resulting resource improvement schedule may be utilized to directly schedule human resources or machine resources for the associated improvement activities. For example, employees may be scheduled for particular, corresponding training activities, or may be granted approval for the training activities (so that the employee may decide whether to participate therein). Similarly for the machine resources, the associated upgrade activities may be scheduled, including, in some implementations, a commencement of associated activities, such as ordering required machine components, or scheduling required maintenance personnel.

In the example of FIG. 1, the resource optimizer 102 is illustrated as being executed using at least one computing device 136, which itself includes at least one processor 138 and a non-transitory computer readable storage medium 140. For example, the at least one computing device 136 may represent one or more computing devices operating in parallel, perhaps in communication over a public or private computer network. For example, in such cases, various components of the resource optimizer 102 may be executed on different ones of the two or more computers. For example, the optimization request handler 122 may be executed at a local computer in conjunction with providing the resource optimization UI 106, while the remaining components of the resource optimizer 102 may be implemented at a backend or cloud-based server computer.

Somewhat similarly, the at least one processor 138 may be understood to represent two or more processors potentially operating in parallel. For example, various operations of the iteration calculator 134 may be executed in parallel using two or more processors. For example, each of the two or more such processors may be assigned a subset of training relationships for which a corresponding optimization variable may be calculated, so that a total value of the optimization variable for the training set may be determined more quickly.

The computer readable storage medium 140 may be understood to represent any known or future non-transitory computer readable storage medium suitable to store instructions that are executable by the at least one processor 138 for providing the various features and functions of the resource optimizer 102 described herein. Further, although shown separately in the simplified example of FIG. 1, the resource repository 104 may be understood to be stored using one or more examples of such non-transitory computer readable storage medium. For example, it may be appreciated in the context of a large corporation or enterprise that the various databases 108-118 of the resource repository 104 may be stored at different locations and accessible by way of appropriate computer network. In this way, it will be appreciated that the resource optimizer 102 is configured to leverage availability of existing data within such a corporation or enterprise, in order to provide resource training schedules that can be shown to increase a profitability or other operational aspect of the corporation or enterprises, so that available resources are utilized and deployed effectively and efficiently.

FIG. 2 is a flowchart 200 illustrating example operations of the system 100 of FIG. 1. In the example of FIG. 2, operations 202-212 are illustrated as separate, sequential operations. However, in various implementations, it will be appreciated that additional or alternative operations or sub-operations may be included, and/or that one or more operations or sub-operations may be omitted. In all such implementations, it may occur that any two or more of the operations or sub-operations may be executed in a partially or completely overlapping or parallel manner, or in a nested, iterative, looped, or branched fashion.

In the example of FIG. 2, an optimization request for generating a resource improvement schedule in which a plurality of resources are scheduled for a plurality of improvement activities may be received, the resource improvement schedule associated with a budget constraint (202). For example, as described, the optimization request handler 122 may receive, perhaps by way of the resource optimization UI 106, such an optimization request in which a set of human resources associated with the human resource database 108 is specified, along with a set of training programs stored using the training resource database 110. In this regard, it will be appreciated that, in some scenarios, the specification of the identified resources and improvement activities may be implicit or pre-configured to some extent. For example, there may be a specific number of training programs within the training resource database 110, and the optimization request may specify, or may assume or have a default setting for, selection of all available training programs.

In other examples, the optimization request may reflect human input, such as requests from individual employees (or their supervisors) for specific training programs. For machine resources, similarly, human operators of specific machines may submit requests for desired machine upgrades.

Furthermore, the optimization request may specify human resources or machine resources by type or role. For example, the optimization request may specify all human resources having a particular job type or education level, or machine resources of a certain type or specific age. Other suitable techniques for specifying desired resources and associated improvement activities may be used, as appropriate.

A resource database may be accessed to retrieve the plurality of resources from a plurality of stored resources (204). For example, the optimization request handler 122 may access the human resource database 108 to retrieve specified human resources, or the machine resource database 112, to retrieve specified machine resources.

An improvement database may be accessed to retrieve the plurality of improvement activities from a plurality of stored improvement activities (206). For example, the optimization request handler 122 may access the training resource database 110 to retrieve specified training programs for human resources, or the machine upgrade database 114, to retrieve machine upgrades for specified machine resources.

An initial resource improvement schedule may be generated that includes a plurality of relationships, each relationship defined between individual resources and individual improvement activities (208). For example, the relationship generator 132 may generate training relationships between individual human resources and individual training programs, or upgrade activities for individual machine resources. As referenced above, example techniques for generating the initial resource improvement schedule are described below with respect to FIG. 3.

Iterations may be executed to improve the initial optimization schedule (210). For example, the iteration controller 130 may govern operations of the relationship generator 132 in conjunction with operations of the iteration calculator 134.

More specifically, as illustrated in the example of FIG. 2 with respect to various sub-operations 210A-210C of operation 210, an optimization variable may be calculated for each relationship (210A). For example, the iteration calculator 134 may access, directly or indirectly, the loss rate predictor 120, the benefit evaluator 124, the cost evaluator 126, and/or the constraint manager 128. More particularly, as described herein, the just-referenced components may be configured to access data stored within the resource repository 104 in order to execute their respective functions and associated calculations, the results of which may be stored, e.g., using the resource improvement schedule database 118. For example, the benefit evaluator 124 may calculate a benefit associated with a particular human resource undergoing a particular training program, taking into account predictions of the loss rate predictor 120 regarding a likely departure or unavailability of the human resource in question in the future.

As also referenced, calculations of the loss rate predictor 120, the benefit evaluator 124, the cost evaluator 126, and the constraint manager 128 may be pre-calculated, where possible, feasible, or desired, so that the iteration calculator 134, in calculating associated optimization variables for a specific set of relationships, merely needs to sum or aggregate the already-calculated optimization variables for the relationship set in question. In other implementation scenarios, it may be possible for the iteration calculator 134 to obtain concurrent processing, so as to obtain values for the optimization variables that are as current as possible.

A preceding resource improvement schedule from a preceding iteration of the current iteration may be sampled, based on values of optimization variables in the preceding resource improvement schedule, to thereby retain a subset of the relationships of the preceding resource improvement schedule (210B). For example, the iteration calculator 134 may be configured to sample the initial resource improvement schedule, or any most-recent resource improvement schedule from a preceding iteration. In general, the iteration calculator 134 may execute such sampling based on values of the optimization variable. For example, in scenarios in which the optimization variable represents, or is associated with, profitability, then the sampling may proceed using sampling techniques that are designed to be relatively likely to retain samples having higher profitability values. More specific examples of sampling techniques are described below with respect to FIG. 4.

Further in the current iteration, it may be determined whether the retained subset has costs greater than the budget constraint, in which case the sampling is re-executed, or, if not, additional relationships are generated for inclusion in a subsequent iteration (210C). For example, as also described below with respect to FIG. 4, the iteration calculator 134 may be configured to utilize the budget constraint obtained in association with the constraint manager 128, so that the current set of training relationships is iteratively sampled and reduced until the remaining or retained subset thereof is compliant with the corresponding budget constraint, or, if necessary, the iteration calculator 134 may utilize the relationship generator 132 to generate additional improvement relationships, until the total number of current improvement relationships has cost which are approximately=, but do not exceed, the relevant budget constraint.

The iterations may be stopped at a final iteration associated with an iteration stop condition, to thereby obtain the resource improvement schedule (212). For example, as referenced, the iteration stop condition may be implemented by the iteration controller 130, and may be defined by one or more of a maximum number of iterations, a maximum quantity of time spent iterating, or an absolute or relative value for the aggregated optimization variables of the final iteration.

In the following example scenarios described with respect to FIGS. 3 and 4, references made to the examples described above in which a resource improvement schedule is generated and optimized for human resources of the human resource database 108 and associated training programs of the training resource database 110. Of course, it will be appreciated from the above description that the same or similar techniques would be applicable with respect to the machine resource database 112 and the machine upgrade database 114.

With respect to such employee training programs, specific training programs may be beneficial in fulfilling new or increased business demands, and/or in increasing efficiency or productivity levels of trained employees. As already described, the associated techniques employed by the resource optimizer 102 in optimizing employee training schedules assumes a specified number of employees having existing skill sets, efficiency levels, and other characteristics, a number of predefined, available training programs, a total training budget, information characterizing business demands, and various other data stored using the human resource database 108 and the training resource database 110.

As described above with respect to the loss rate predictor 120 of FIG. 1, some of the difficulties associated with optimizing a resource improvement schedule are associated with the fact that employees may be associated with various probabilities of departure or unavailability. Moreover, a relative probability of an employee departing may be affected (e.g., increased) in conjunction with receipt of a particular training program.

Equation 1 provides an example technique that may be executed by the loss rate predictor 120 to determine or estimate a rate of turnover of a set of employees:

$$p ( t + i \vert t ) = \frac{{n}_{t + i}}{{n}_{t + i} + {m}_{t + i}} \qquad Equation 1$$

In Equation 1, iεZ⁺ (Z⁺ is the positive integer set) and nₜ₊ᵢ denotes the number of employees who departed after reaching t+i months of services. Meanwhile, mₜ₊ᵢ denotes the number of employees who stay in the company after t+i months of services.

Thus, in the example of FIG. 1, the turnover rate estimation calculates a conditional probability that an employee who has been employed for t months (or other time period, such as days, or years), so as to estimate whether the employee will depart at month t+i.

Thus, Equation 1 illustrates an example technique that may be used by the loss rate predictor 120 to calculate a conditional probability of departure for a particular employee, based on historical timings of departures as recorded using the human resource database 108. Of course, Equation 1 provides a single example, and additional or alternative parameters may be included. For example, the historical data within the human resource database 108 may be utilized to modify Equation 1 so that the resulting conditional probability explicitly considers training programs taken by employees historically, to thereby quantify an impact of receiving a specific training program with respect to a likelihood that the employee will depart within a specific quantity of time after completion of the training program.

In the example of FIGS. 3 and 4, the cost evaluator 126 may be configured to calculate a training cost, including any opportunity cost lost as a result of reduced production of a particular employee while undergoing a given training program. Thus, a total training cost for an employee Eᵢ to take a training program Tⱼ may be provided using Equation 2:

cost(Eᵢ,Tⱼ)=salary(Eᵢ)*train time(Tⱼ)+fee(Tᵢ) Equation 2

In Equation 2, salary(Eᵢ) is the unit salary, train_time(Tⱼ) is the training time for the training program Tⱼ, and fee(Tⱼ) is the training fee for the training program Tⱼ.

Meanwhile, the benefit evaluator 124 may calculate a training benefit for an employee Eₜ to take a training program Tⱼ, as provided in Equation 3:

benefit(Eᵢ,Tⱼ)=eff_imp(Eᵢ,Tⱼ)*stay_time(Eᵢ) Equation 3

In Equation 3, off_time(Eᵢ,Tⱼ) is the efficiency improvement after taking training Tⱼ and stay_time(Eᵢ) denote the time that the employee will stay at the company after the training program is completed. In this regard, it will be appreciated that efficiency improvements may be characterized in any appropriate manner, such as in terms of relative quantity or efficiency of production, and/or increased production output per unit time.

As just referenced, Equation 3, representing a training benefit for a particular employee/training program relationship, depends on an amount or extent to which the employee remains or is retained following completion of the specific training program. As also shown in Equation 3, and as used in conjunction with explaining subsequent equations, the term stay_time (Eᵢ) may be calculated using the turnover probability calculation of Equation 1, as shown in Equation 4:

$$\begin{matrix} stay\_time ( {E}_{i} ) = \text{?} {\sum }_{t = 1} p ( t + i \vert t ) * i & Equation 4 \\ \text{?} \text{indicates text missing or illegible when filed} & \end{matrix}$$

In Equation 4, t represents a time that the employee Eᵢ has already been an employee. Thus, as may be understood from the description of the loss rate predictor above, an optimization variable such as profitability that depends on the benefit calculations of Equations 3 and 4 may be calculated for each relationship based on a predicted future availability of the associated resource, as determined from historical analysis of availabilities of similar resources.

Accordingly, a profit for providing an employee Eᵢ, with training program Tⱼ may be used as the optimization variable optimized by the resource optimizer 102. As may be observed in Equation 5, profit may be defined in terms of the already-calculated benefit and cost.

profit(Eᵢ,Tⱼ)=benefit(Eᵢ,Tⱼ)−cost(Eᵢ,Tⱼ) Equation 5

Then, for all included or specified employees and training programs, a total business profit may be determined as a sum or aggregation of calculated profits for each individual training relationship being considered, as shown in the example of Equation 6.

$$\begin{matrix} profit = \text{?} \sum \text{?} \sum profit ( {E}_{i} , {T}_{j} ) \pm f ( {E}_{i} , {T}_{j} ) & Equation 6 \\ \text{?} \text{indicates text missing or illegible when filed} & \end{matrix}$$

In Equation 6, f(Eᵢ,Tⱼ) is a control function. Specifically, if the training relationship between Eᵢ and Tⱼ exists, f(Eᵢ,Tⱼ)=1, otherwise f(Eᵢ,Tⱼ)=0.

Thus, Equation 6 represents a calculation for an optimization variable, such as profit. Additional or alternative optimization variables may be used, such as, for example, reliability, quality of service, or other suitable metric, or combinations thereof.

Meanwhile, the constraint manager 128 may receive and parameterize at least a budget constraint specifying a maximum total training cost for sets of training relationships. That is, the budget constraint can be compared against the total training cost already described above with respect to Equation 2.

Another example constraint includes a quantified business demand for a number of employees having specific skill sets and/or efficiency levels. For example, a business demand for a specific skill and associated efficiency level may be represented as a total number of employees required to possess the skill in question and having at least the specified efficiency level. By considering this constraint, it will be appreciated that, since training programs either enrich an employee skill set and/or improve an efficiency level of associated skill sets, the training optimization techniques described herein enable an employee's skill set to conform to a relevant business demand, to an extent possible under the constraint of the total training budget.

In the examples of FIGS. 3 and 4, FIG. 3 generally illustrates a flowchart 300 providing example initialization operations that may be executed using the iteration controller 130 and the relationship generator 132. Meanwhile, FIG. 4 is a flowchart 400 illustrating optimization iterations that may be calculated using the iteration controller 130, the relationship generator 132, and the iteration calculator 134, and based on the output of the process of FIG. 3.

Thus, in the example of FIG. 3, the iteration controller 130 may obtain a total training cost for a specified set of employees in training programs, as described above with respect to equation 2. Assuming that the calculated total training cost is not greater than the training budget (304), the relationship generator 132 may proceed to randomly generate a training relationship (306), whereupon the generated training relationship may be stored (308), e.g., using the resource improvement schedule database 118.

In some examples, in initial operations of FIG. 3, no training relationship may have been generated, so that a total training cost is nominal or zero, and thus well underneath the associated training budget. Upon the random generation of a training relationship and associated storing thereof, the new, updated training cost may be calculated (302). As the new total training cost would presumably still be within the budget, a second training relationship may be randomly generated and stored, and this process may continue iteratively until the total training cost for the set of randomly generated training relationships exceeds the available training budget (304). At this point, an initial set of training relationships has been generated that is relatively close to the total training budget.

In other example implementations, additional or alternative techniques may be utilized to generate the initial set of training relationships. For example, it may be beneficial to generate a larger number of initial training relationships, rather than generating the training relationships individually. In other example implementations, other available parameters may be considered such as parameters related to benefits associated with proposed training schedules, as may be obtained from, or using, the benefit evaluator 124. In any case, the example of FIG. 3 provides an example scenario in which an initial set of training relationships can be generated quickly and in conformance with a total training budget, on the assumption that the iterations of FIG. 4 will improve and optimize the randomly generated initial set of training relationships.

In the example of FIG. 4, iterations and associated calculations by the iteration calculator 134 may begin with a calculation of profit as the optimization variable, in accordance with Equations 5 and 6, to thereby obtain a total profit for the initial set of randomly generated training relationships (402). Then, the business demand constraint may be considered (404). That is, for each training relationship in the considered set of training relationships, the obtained skill sets and/or increased efficiency associated with the corresponding training program may be compared to an associated business demand. If the obtained skills and efficiencies exceed the business demand for those skills and efficiencies, the profit as the optimization variable may be recalculated (406), e.g., by removing the benefit parameter from Equation 5. In other words, without sufficient business demand, the improved skills and efficiencies will not contribute to a total profitability.

Otherwise, if the skill sets and/or efficiencies do not exceed the related business demand (404), then the iteration calculator 134 may proceed to execute the type of sampling operation referenced above. For example, the iteration calculator 134 may calculate a sampling probability table (408), e.g., in conjunction with a Gibbs sampling technique.

In this regard, the example of Gibbs sampling generally refers to a sampling algorithm for generating a Markov chain of Markov variable or values. That is, such Markov chains refer to “memoryless” values, each of which is determined based on a current state or value, and not on any preceding state or value, or sequence thereof.

Of course, other sampling techniques also may be used, but in the present example, in more detail, such a probability table may be calculated based on the calculated profitability of each training relationship in the current set of training relationships. More specifically, the probability that a relationship Rᵢ will be removed from the solution set is expressed in Equation 7:

$$\begin{matrix} p ( {R}_{i} ) = \frac{( 1 - profit ( {R}_{i} ) )}{\sum \text{?} profit ( {R}_{i} )} & Equation 7 \\ \text{?} \text{indicates text missing or illegible when filed} & \end{matrix}$$

In Equation 7, profit(Rᵢ) is the profit of Rᵢ and Σᵢⁿprofit(Rᵢ) denotes the sum of the all the profit in the solution set. Thus, Equation 7 represents a probability that a given training relationships will be removed from the relationship set as part of the sampling process.

As may be appreciated from Equation 7, a training relationship having a relatively high profit level will be less likely to be removed in the training relationship associated with a relatively smaller profit level. In this way, a number of training relationships may be removed from the set of training relationships (410).

After obtaining a total training cost (412) associated with remaining training relationships, the iteration calculator 134 may determine whether the total training cost exceeds the training budget (414). If so, then sampling of the already-sampled set of training relationships may be executed again (408, 410), and an updated total training cost may be obtained (412). These calculations may continue until the total training cost is less than or equal to the total training budget (414).

At this point, if an iteration stop condition has not been reached (415), then at least one new training relationship may be randomly generated (416), using the relationship generator 132. The training relationship may then be stored for inclusion within the current set of training relationships (418).

Thereupon, the next iteration may proceed with a calculation of total profit for the training relationship set of the current iteration (402). The business demand constraint may then be reconsidered (404), e.g., in case the most-recently generated training relationships include combinations of employees in training programs that would not satisfy a current or projected business demand. The iteration may continue with any necessary profit recalculations to reflect any relevant lack of business demand, followed by the sampling of the current set of training relationships. As illustrated with respect to operation 415, if a stop condition has not yet been reached, then generation of new training relationships may proceed (416). Otherwise, the iterative process may be halted. As already described, the iteration stop condition may include, e.g., a maximum number of iterations, or a predefined total training profit, or both

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to cause at least one computing device to:
receive an optimization request for generating a resource improvement schedule in which a plurality of resources are scheduled for a plurality of improvement activities, the resource improvement schedule associated with a budget constraint;
access a resource database to retrieve the plurality of resources from a plurality of stored resources;
access an improvement database to retrieve the plurality of improvement activities from a plurality of stored improvement activities;
generate an initial resource improvement schedule that includes a plurality of relationships, each relationship defined between individual resources and individual improvement activities;
execute iterations to improve the initial optimization schedule, each current iteration including
calculating an optimization variable for each relationship;
sampling a preceding resource improvement schedule from a preceding iteration, based on values of optimization variables in the preceding resource improvement schedule, to thereby retain a subset of the relationships of the preceding resource improvement schedule,
determining whether the retained subset has costs greater than the budget constraint, and re-executing the sampling if so, or, if not, generating additional relationships for inclusion in a subsequent iteration, and
stop the iterations at a final iteration associated with an iteration stop condition, to thereby obtain the resource improvement schedule.

2. The computer program product of claim 1, wherein the plurality of resources include human resources, and the plurality of improvement activities include training programs for which at least some of the plurality of human resources are eligible.

3. The computer program product of claim 1, wherein the plurality of resources include machine resources, and the plurality of improvement activities include repair, upgrade, or replacement activities applicable to at least some of the machine resources.

4. The computer program product of claim 1, wherein the instructions, when executed by the at least one computing device, are further configured to:
generate the initial resource improvement schedule including randomly generating individual relationships until a designated relationship between a total cost of the generated relationships and the budget constraint is reached.

5. The computer program product of claim 1, wherein the instructions, when executed by the at least one computing device, are further configured to:
calculate the optimization variable for each relationship based on a predicted future availability of the associated resource, as determined from historical analysis of availabilities of similar resources.

6. The computer program product of claim 1, wherein the instructions, when executed by the at least one computing device, are further configured to:
calculate the optimization variable for each relationship based on a total benefit associated with the relationship, relative to a total cost of the associated improvement activity.

7. The computer program product of claim 1, wherein the instructions, when executed by the at least one computing device, are further configured to:
calculate the optimization variable for each relationship based on whether a demand constraint for the improvement activity of the associated relationship is met.

8. The computer program product of claim 1, wherein the instructions, when executed by the at least one computing device, are further configured to:
execute the sampling including performing a Gibbs sampling of the resource improvement relationship to retain the subset of the relationships of the preceding resource improvement schedule.

9. A method of executing instructions stored on a non-transitory computer-readable storage medium using at least one processor, the method comprising:
receiving an optimization request for generating a resource improvement schedule in which a plurality of resources are scheduled for a plurality of improvement activities, the resource improvement schedule associated with a budget constraint;
accessing a resource database to retrieve the plurality of resources from a plurality of stored resources;
accessing an improvement database to retrieve the plurality of improvement activities from a plurality of stored improvement activities;
generating an initial resource improvement schedule that includes a plurality of relationships, each relationship defined between individual resources and individual improvement activities;
executing iterations to improve the initial optimization schedule, each current iteration including
calculating an optimization variable for each relationship;
sampling a preceding resource improvement schedule from a preceding iteration, based on values of optimization variables in the preceding resource improvement schedule, to thereby retain a subset of the relationships of the preceding resource improvement schedule,
determining whether the retained subset has costs greater than the budget constraint, and re-executing the sampling if so, or, if not, generating additional relationships for inclusion in a subsequent iteration, and
stopping the iterations at a final iteration associated with an iteration stop condition, to thereby obtain the resource improvement schedule.

10. The method of claim 9, wherein the plurality of resources include human resources, and the plurality of improvement activities include training programs for which at least some of the plurality of human resources are eligible.

11. The method of claim 9, wherein the plurality of resources include machine resources, and the plurality of improvement activities include repair, upgrade, or replacement activities applicable to at least some of the machine resources.

12. The method of claim 9, further comprising generating the initial resource improvement schedule including randomly generating individual relationships until a designated relationship between a total cost of the generated relationships and the budget constraint is reached.

13. The method of claim 9, further comprising calculating the optimization variable for each relationship based on a predicted future availability of the associated resource, as determined from historical analysis of availabilities of similar resources.

14. The method of claim 9, further comprising calculating the optimization variable for each relationship based on a total benefit associated with the relationship, relative to a total cost of the associated improvement activity.

15. The method of claim 9, further comprising calculating the optimization variable for each relationship based on whether a demand constraint for the improvement activity of the associated relationship is met.

16. The method of claim 9, further comprising executing the sampling including performing a Gibbs sampling of the resource improvement relationship to retain the subset of the relationships of the preceding resource improvement schedule.

17. A system comprising:
at least one processor;
a non-transitory computer-readable storage medium storing instructions executable by the at least one processor, the system including
an optimization request handler configured to cause the at least one processor to receive an optimization request for generating a resource improvement schedule in which a plurality of resources are scheduled for a plurality of improvement activities, the resource improvement schedule associated with a budget constraint;
a loss rate predictor configured to calculate a predicted future availability of a resource, as determined from historical analysis of availabilities of similar resources; and
an iteration calculator configured to cause the at least one processor to execute iterations to obtain the resource improvement schedule, each current iteration including
calculating an optimization variable for each relationship, based on the predicted future availability of the resource of the corresponding relationship;
sampling a preceding resource improvement schedule from a preceding iteration, based on values of optimization variables in the preceding resource improvement schedule, to thereby retain a subset of the relationships of the preceding resource improvement schedule,
determining whether the retained subset has costs greater than the budget constraint, and re-executing the sampling if so, or, if not, generating additional relationships for inclusion in a subsequent iteration.

18. The system of claim 17, wherein the plurality of resources include human resources, and the plurality of improvement activities include training programs for which at least some of the plurality of human resources are eligible, and further wherein the loss rate predictor is configured to calculate the predicted future availability including an amount of time before the human resource is no longer available.

19. The computer program product of claim 1, wherein the plurality of resources include machine resources, and the plurality of improvement activities include repair, upgrade, or replacement activities applicable to at least some of the machine resources, and further wherein the loss rate predictor is configured to calculate the predicted future availability including an amount of time before the machine resource malfunctions.

20. The system of claim 17, wherein the iteration calculator is further configured to execute the sampling including performing a Gibbs sampling of the resource improvement relationship to retain the subset of the relationships of the preceding resource improvement schedule.
